(19) United States
(12) Patent Application Publication
(10) Pub. No.: US 2006/0257230 A1
(43) Pub. Date: Nov. 16, 2006

(54) Retaining ring for shaft

(76) Inventors: Kouichi Tanaka, Nagoya-shi (JP); Yoshichika Tanaka, Nagoya-shi (JP)

Correspondence Address: FLYNN THIEL BOUTELL & TANIS, P.C., 2026 RAMBLING ROAD, KALAMAZOO, MI, 49008-1631, US

(21) Appl. No.: 11/409,309

(22) Filed: Apr. 21, 2006

(30) Foreign Application Priority Data
May 13, 2005 (JP) 2005-140955

(51) Int. Cl. F16B 39/24

(52) U.S. Cl. 411/221; 411/147

(57) ABSTRACT

Respective portions to contact a shaft do not contact the shaft in a stable condition. At least three projections 3, 3a, . . . are formed in an inner periphery of a C-shaped base material 2 that has an opening portion 1 at one place of an outer periphery that expands toward the outer circumference, and spaces between the adjacent projections 3, 3a, . . . are made inner notches 5, 5a, . . . . Inner edges of the projections 3, 3a, . . . are shaped like a convex circular arc circumscribed to an outer circumferential surface of a mounting region of the shaft S. Thus, the respective projections 3, 3a, . . . can abut the shaft at one point, so that the retaining ring for shaft of the present application can be mounted to the shaft in a good posture.

### BACKGROUND ART

1. Field of the Invention

The present invention relates to a retaining ring for shaft to be fitted on an annular groove of the shaft for positioning or preventing possible fall-off of a part such as a bearing mounted onto the shaft.

2. Description of the Related Art

As a conventional retaining ring for shaft, an “E-type Retaining Ring” of JIS 2805 is typical. The E-type retaining ring shall be made of steel for springs or stainless steel for springs and have a slightly smaller inside diameter than the annular groove, wherein a notch is formed for facilitating elastic deformation at two places in inner periphery and an opening portion is provided at one place in outer periphery. Then, the configuration is such that the E-type retaining ring is mounted by manually holding mounting tool on a tip of which the E-type retaining ring is set, or setting it to a dedicated machine, pressing both sides of the opening portion of the E-type retaining ring against the annular groove, expanding the opening portion, and thus not only fitting the E-type retaining ring but also narrowing the annular groove due to resilient restoration force to fasten it to the shaft.

In addition, like the above E-type retaining ring, there is available a clip that prevents fall-off by being fitted into a small-diameter groove of a motor shaft, the clip being comprised of a substantially C-shaped base that elastically deforms in a radial direction and a plurality of extensions that not only extend to a center from the base but also are maintained in a fitted state in which an end abuts the small-diameter groove (Refer to Patent Document 1, for instance).
[Patent Document 1] Unexamined Patent Publication No. 2002-119011 (Claims, FIG. 2 (a), and FIG. 3 (a))

### SUMMARY OF THE INVENTION

However, the above E-type retaining ring or the clip described in the Patent Document 1 had the problem that as a contact portion abutting the shaft is concave-arc-shaped, an entire concave arc shape of respective contact regions does not abut the shaft if there is any dimensional error on the side of the retaining ring or the shaft, for instance, the respective contact portions not stably contacting the shaft, thus destabilizing the mounted condition.

In view of the problem that respective contact portions based on the conventional technique do not abut the shaft in a stable condition, the present invention solves the above problem by forming four lobes in an inner periphery of a C-shaped base material having at one place in an outer periphery an opening portion that expands toward an outer circumference, making a space between the adjacent lobes an inner notch, allowing inner edges of the respective lobes to contact the shaft at one point so as to be mountable in a stable profile.

In short, according to the present invention four lobes are formed in the inner periphery of the C-shaped base material that has an opening portion at one place of the outer periphery that expands toward the outer periphery, a space between the adjacent lobes is made as an inner notch, inner edges of the lobe are shaped like a convex-arc shape circumscribed to a circumferential surface of the mounting region in the shaft. Thus, because of strong resilient restoration force of the retaining ring for shaft in an outer fitted state, an end of each lobe, namely, the convex-arc shaped inner edge can contact the circumferential surface of the mounting region, i.e., the bottom of the annular groove at one point and presses and biases it in the center direction of the shaft. Hence, the present invention can exert full fastening capability to the shaft and maintain mounted condition in a balanced manner.

In addition, as the diameter of the inner edge in the lobe increases, a width of a rear anchor of the lobe becomes wider, enabling concentration of the elastic restoration force of the base material on the contact point on the side of the shaft. This makes it possible to exert full fastening capability to the shaft and maintain mounted condition in a balanced manner.

In addition, according to the retaining ring of this application can prevent fall-off of the retaining ring from the shaft even when relatively heavy load in the shaft core direction acts on the retaining ring of this application which is in a mounted state, because almost all the parts of the lobes including the ends reside inside the annular groove when the retaining ring is fitted into the annular groove, and thus all the lobes can bear load in the shaft core direction.

In addition, like to the conventional E-type retaining ring, through an attempt to downsize, projections from the shaft S can be reduced. Thus, even if the retaining ring is installed in a machine with a complex inner structure, it can stand clear of other components and contribute to downsizing of assembled products.

In addition, not only the inner edge of the lobes are circumscribed to the mounting region in the shaft, by forming three lobes in the inner periphery of the C-shaped base material and making a space between the adjacent lobes an inner notch, but also the width of the rear anchor of the lobes becomes wider by making diameter of the convex-arc shape greater than that of the circumferential surface of the mounting region. Hence, the resilient restoration force of the base material can be concentrated on the contact point on the side of the shaft, and thus the fastening capability to the shaft can be fully exerted, and the mounted condition can be maintained in a balanced manner.

Not only the inner edge of the lobes and both edges of the inner notch can be made smoothly continuous, but also a back corner of the inner notch is made an R-shaped surface, wherein shapes according to such the shape, namely, a projection forming region and the inner notch can be made smoothly continuous, and yet an area where a die blade contacts the side of material of the inner edge notch and the lobe forming region in a punch can be set wider. Thus, a shape in consideration of life of the die blade and punch, etc. can be created.

Since in the outer periphery of the base material, an outer notch is provided in a region corresponding to a space between adjacent inner notches, the lobes can be narrow and substantially U-shaped due to provision of the outer notch and thus can easily subject to elastic deformation. This allows one to mount and detach the retaining ring without applying force more than needed, facilitating simplification of mounting and detaching, yet preventing the retaining ring from jumping, and thus improving safety during mounting/detaching operation.

Furthermore, as elastic deformation is now easy to make without applying force more than needed, not only mounting/detaching operation of the retaining ring can be facilitated, but also safety in mounting/detaching operation can be enhanced, being free from possible jump due to deflecting E-type retaining ring.

In addition, the outer notch allows one to set a retaining ring on a mounting tool or a dedicated machine in a good posture.

As a concave portion is formed in the outer circumference of a region opposed to the opening portion of the base material, one can set the retaining ring for shaft on a mounting tool or a dedicated machine in a good posture.

### BRIEF DESCRIPTION OF THE DRAWINGS

FIG. 1 is a front view showing the first embodiment of the retaining ring for shaft according to the present invention;

FIG. 2 is a cross-sectional view of FIG. 1 cut along the line Y1-Y1;

FIG. 3 is a front view showing a retaining ring for shaft of the first embodiment to which outer notches are provided;

FIG. 4 is a cross-sectional view of FIG. 3 cut along the line Y2-Y2;

FIG. 5 is a front view of the retaining ring for shaft of the first embodiment to which lobes are provided;

FIG. 6 is a cross-sectional view of FIG. 5 cut along the line Y3-Y3;

FIG. 7 is a front view showing the retaining ring for shaft of the first embodiment to which lobes are provided;

FIG. 8 is a cross-sectional view of FIG. 7 cut along the line Y4-Y4;

FIG. 9 is a front view showing the retaining ring for shaft of the first embodiment to which concavities are provided;

FIG. 10 is a cross-sectional view of FIG. 9 cut along the line Y5-Y5;

FIG. 11 is a front view showing the second embodiment of the retaining ring for shaft according to the present invention;

FIG. 12 is a cross-sectional view of FIG. 11 cut along the line Y6-Y6;

FIG. 13 is a front view showing a retaining ring for shaft of the second embodiment to which deep outer notches are provided;

FIG. 14 is a cross-sectional view of FIG. 13 cut along the line Y7-Y7;

FIG. 15 is a front view of the retaining ring for shaft of the second embodiment to which shallow outer notches are provided;

FIG. 16 is a cross-sectional view of FIG. 15 cut along the line Y8-Y8;

FIG. 17 is a front view showing the retaining ring for shaft of the second embodiment to which concavities are provided;

FIG. 18 is a cross-sectional view of FIG. 17 cut along the line Y9-Y9;

FIG. 19 is a cross-sectional view showing a state in which the retaining ring for shaft of the first embodiment is mounted on the shaft;

FIG. 20 is a cross-sectional view showing a state in which the retaining ring for shaft of the second embodiment is mounted on the shaft; and

FIG. 21 is a schematic plan view of a partial section of a die blade and a punch by the retaining ring for shaft of the first and the second embodiments is punched.

### DESCRIPTION OF THE PREFERRED EMBODIMENTS

Referring now to the accompanying drawings, embodiments of the present invention will be described.

A retaining ring for shaft according to one embodiment of the present invention is symmetrically stamped and formed. A plurality of lobes 3, 3a . . . serving as projections are formed integral with a C-shaped base material 2 in an inner periphery thereof. The base material 2 has an opening portion 1 at one place of an outer periphery thereof. Inner edges 4, 4a . . . of the lobes 3, 3a . . . are then formed in a convex-arc shape circumscribed to an outer circumferential surface of a mounting region in a shaft S. Spaces between the adjacent lobes 3, 3a, . . . are made inner notches 5, 5a, . . . .

The base material 2 is made of metal such as steel for springs or stainless steel for springs that has excellent elasticity. A diameter d of a circle tangent to the inner edges 4, 4a . . . in all the lobes 3, 3a . . . is set slightly smaller than a diameter D of the mounting region in the shaft S.

The opening portion 1 is so formed as to expand toward the outer circumference side, and large circular arch shaped chamfers 6, 6a are formed at both corners on the opening side of the opening portion 1 at the outer circumference of the base material 2. Although a width of a back side of the opening portion 1 is set narrower than a diameter 2d of the tangent circle, preferably, the width be set such that a deformation amount during mounting is suppressed and the retaining ring may not easily fall off from the shaft S while it is mounted.

In addition, an expansion angle of the opening portion 1 is preferably about 10 to 20 degrees. However, it shall not be limited thereto. If the width of the back side of the opening portion 1 is set slightly narrower than the diameter 2d of the tangent circle, extended intersection points on both sides of the opening portion in the base material 2 will be set to a farther position than the center of the tangent circle.

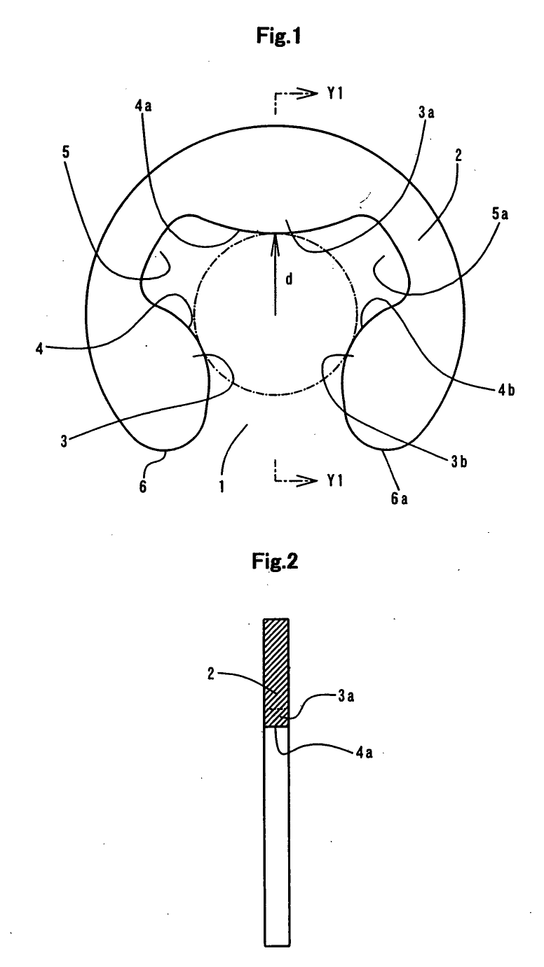

To be specific, FIG. 1 to FIG. 10 are a front view and a front central vertical section showing a first embodiment of the retaining ring according to the present invention, wherein these lobes 3, 3a, 3b are formed in the inner periphery of the base material 2, and the space between the adjacent lobes 3, 3a and the space between the adjacent lobes 3a,3b are made inner notches 5, 5a, while the inner edges 4, 4a, 4b of the lobes 3, 3a, 3b are made into convex-arch shape having a larger diameter than that of the outer circumferential surface of the mounting region in the shaft S, and the diameter of the central lobe 3a is made larger than that of the lobes 3, 3b on both sides of the opening portion 1.

In addition, not only the inner edges 4, 4a, 4b of the lobes 3, 3a, 3b and both lateral edges of the inner notches 5, 5a are made smoothly continuous, but also the inner edges 4, 4b of the lobes 3, 3b on the both sides of the opening portion 1 are made smoothly continuous, and further, both corners on the back of the inner notches 5, 5a are chamfered into a letter R shape.

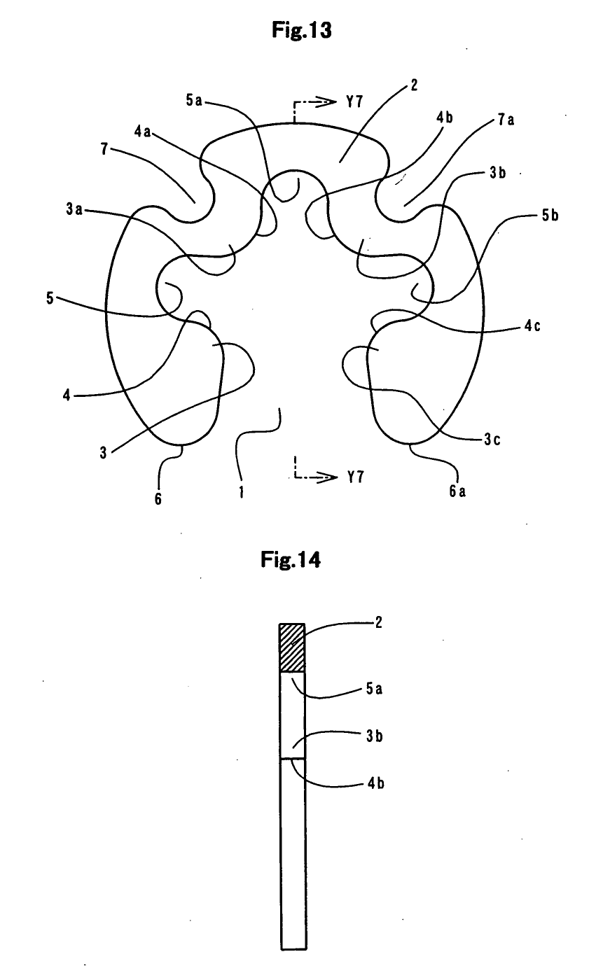

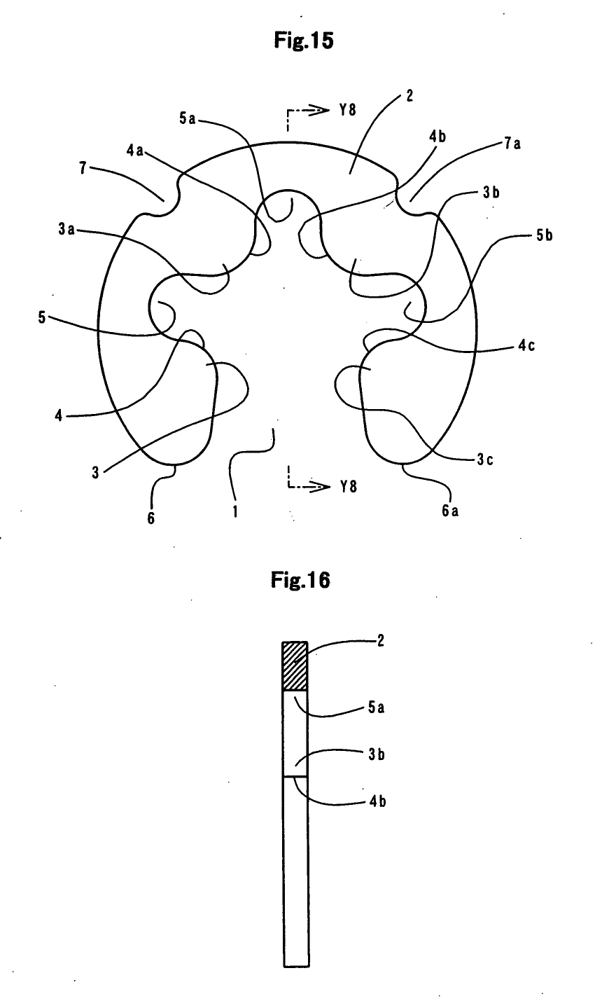

FIG. 11 to FIG. 18 are a front view and a front central vertical section showing a second embodiment of the retaining ring for shaft according to the present invention. Four lobes 3, 3a, 3b, and 3c are formed in the inner periphery of the base material 2, and three inner notches 5, 5a, 5b are formed between the adjacent lobes 3 and 3a, between 3a and 3b and between 3b and 3c.

In addition, not only the inner edges 4, 4a 4b, and c of the lobes 3, 3a, 3b, and 3c and lateral edges on the both sides of the inner notches 5, 5a, 5b are made smoothly continuous, but also the inner edges 4, 4c of the lobes 3, 3c on both sides and lateral edges of both sides of the opening portion 1 are made smoothly continuous. Furthermore, an entire shape of the inner notches 5, 5a and 5b is made so as to be U-shaped, with the side formed into a circular arc, namely, both corners in the back are chamfered into a letter R shape.

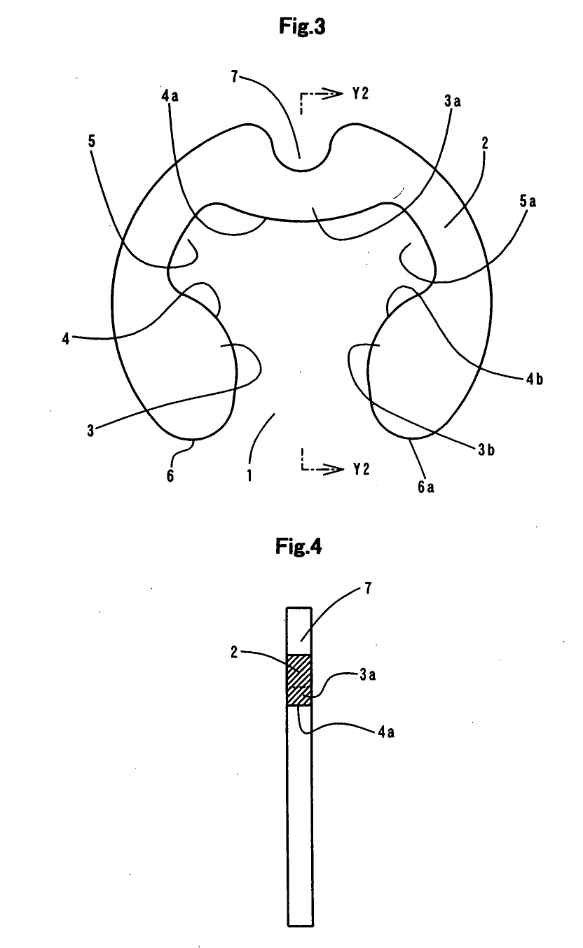

As shown in FIG. 3 and FIG. 4, an outer notch 7 may be formed in regions between the two inner notches 4, 4a in the outer periphery of the retaining ring for shaft of the first embodiment, or the two outer notches 7, 7a may be formed respectively in regions corresponding to those between the three inner notches 5, 5a, 5b in the outer periphery of the retaining ring for shaft of the second embodiment.

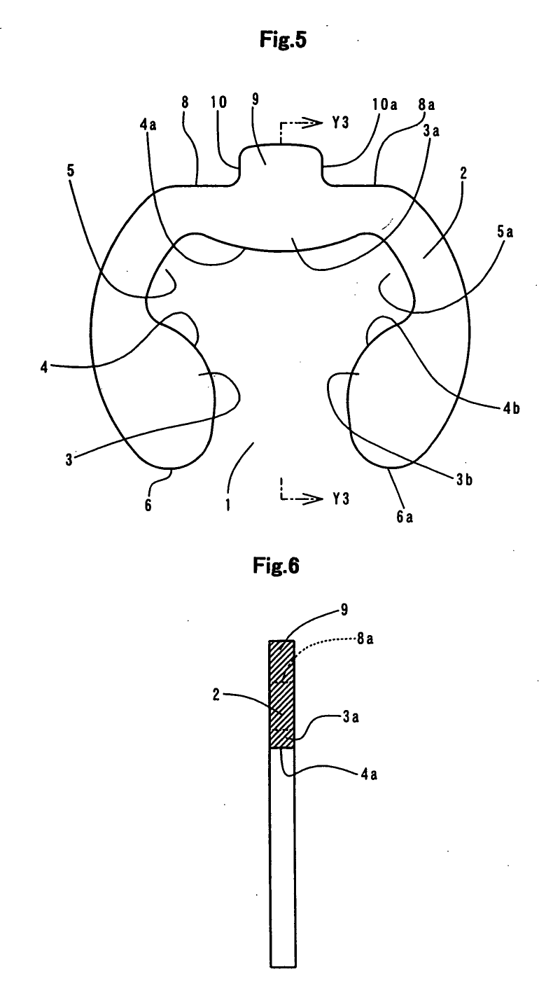

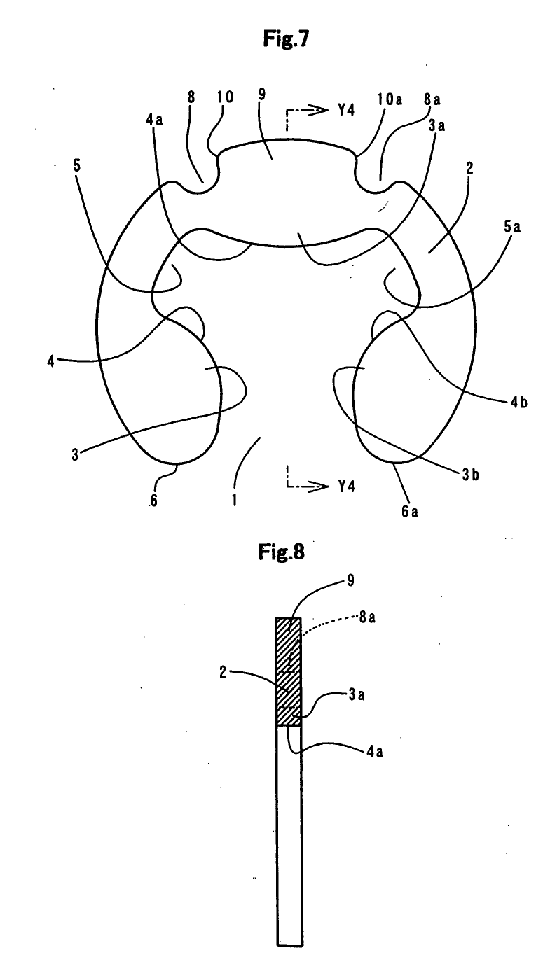

As shown in FIG. 5 to FIG. 8, notches 8, 8a are formed in the two upper parts in the outer periphery of the retaining ring for shaft of the second embodiment, and formed therebetween is a lobe 9. The notches 8, 8a may be shaped like a perpendicular step as shown in FIG. 5 and FIG. 6, or shaped like a shallow U as shown in FIG. 7 and FIG. 8 and both lateral parts of the lobe 9 shall provide contact portions 10, 10a for tool such as pincers, pliers, etc. for removing the retaining ring for shaft from the shaft S.

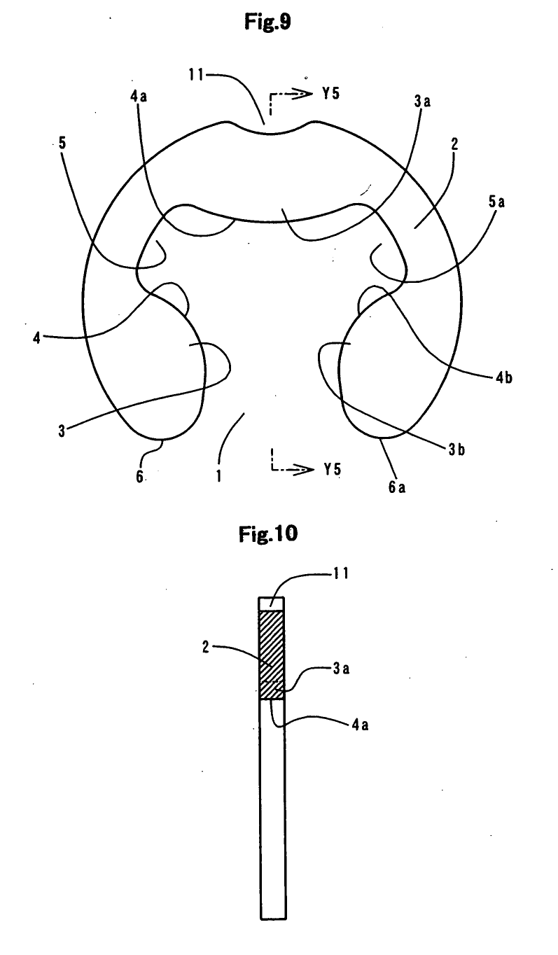

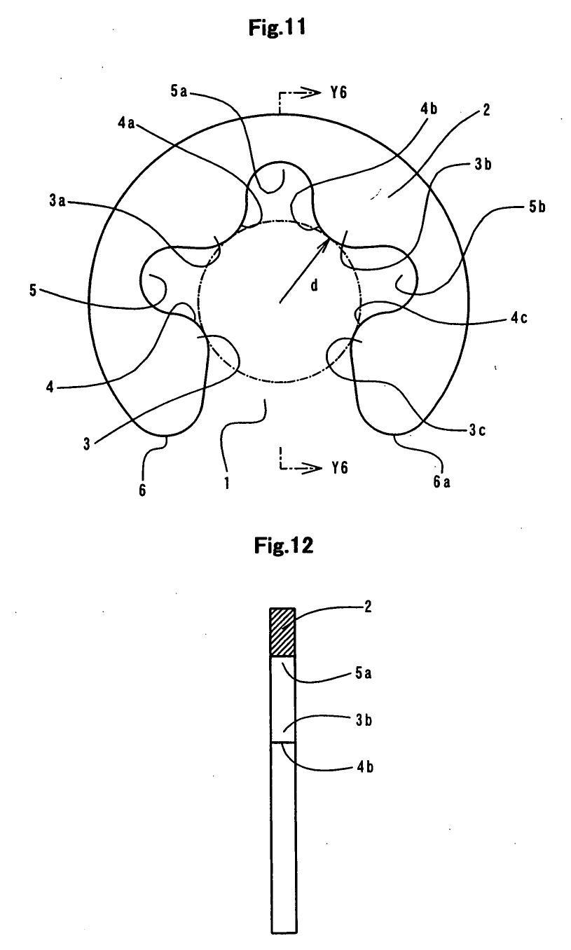

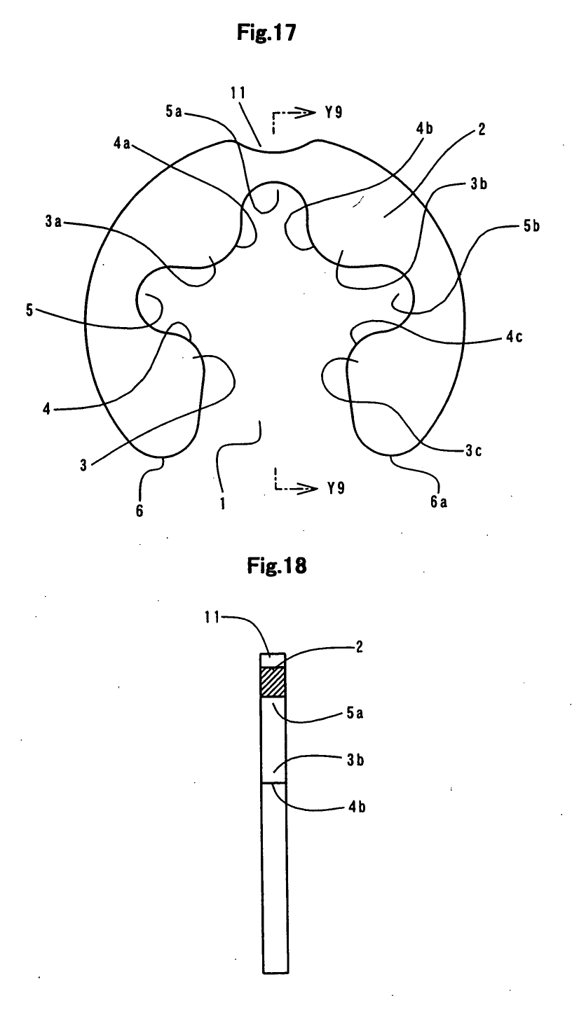

As shown in FIG. 9, FIG. 10, FIG. 17 and FIG. 18, a circular arc concave portion 11 may be formed at an upper center of the top of the outer periphery in the retaining rings for shaft of the first and the second embodiments.

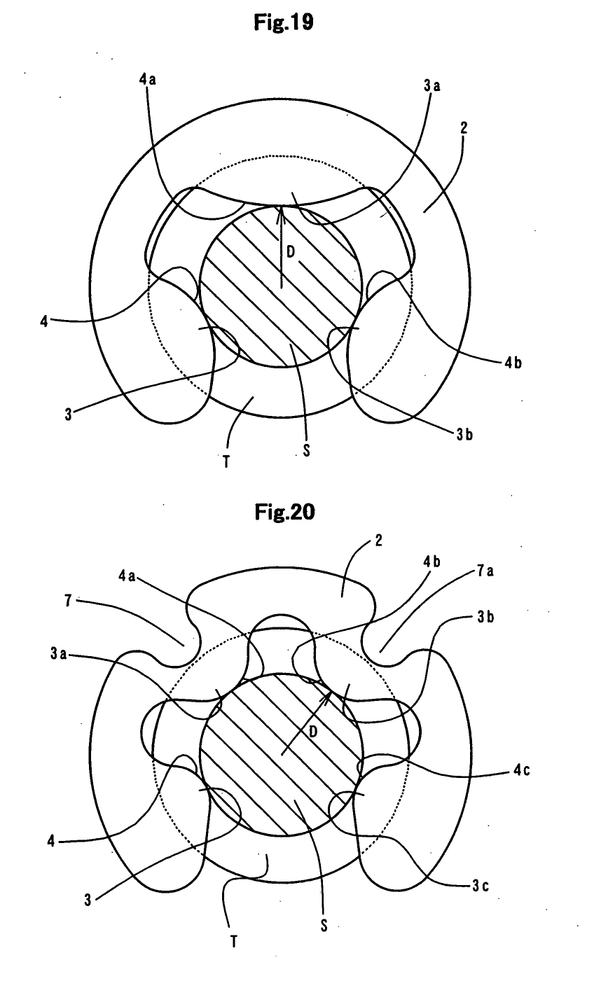

Now the following deals with an operation of the retaining ring for shaft according to the present invention. When the retaining ring for shaft is mounted to the shaft S, first, both sides of the opening portion 1 are made to abut and pressed against the annular groove T. In the course of the pressing process, the opening portion 1 sequentially expands, and when the opening portion 1 fully expands, an elastic restoring force acts such that the opening portion 1 tries to revert to an initial form. However, the inner edges 4, 4a, . . . of the lobes 3, 3a . . . contacting a bottom of the annular groove T, with a somewhat deformed state remaining, the retaining ring is mounted in the annular groove T as shown in FIG. 19 and FIG. 20. If there are the outer notches 5, 5a . . . as shown in FIG. 20, deformation can be achieved with less pressing force when the retaining ring is mounted.

When the retaining ring is removed from the shaft S, the outer circumferential region or the lobe 9 may be held and pulled with such a tool as pincers or pliers, expanding the opening portion 1, so that the retaining ring can be removed from the shaft S.

If there is any one of the outer notches 5, 5a . . . or the concave portion 9 in a region opposed to the opening portion 1 in the base material 2, the base material 2 can be set to a mounting tool or a dedicated machine in a good posture.

As for a retaining ring for shaft of the present application, even if there is some dimensional error on the side of shaft S or the retaining ring for shaft, the inner edges 4, 4a, . . . of the respective lobes 3, 3a abut the bottom of the annular groove at one point, and thus all the inner edges 4, 4a, . . . of the lobes 3, 3a automatically abut it.

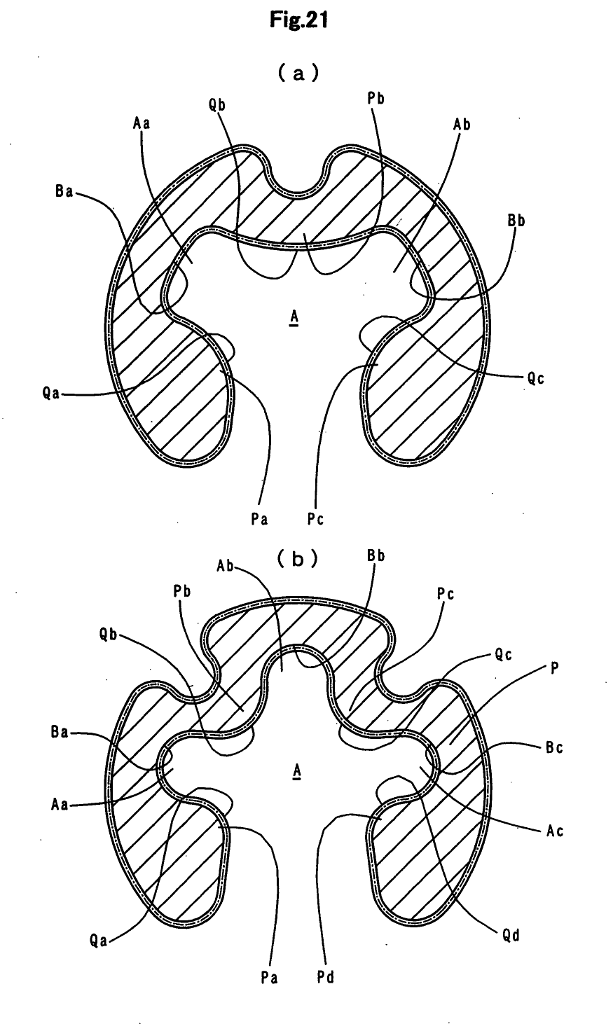

As shown in FIGS. 21 (a) and (b), since inner notch forming regions Aa, Ab, Ac of a die blade A and lobe forming regions Pa, Pb, Pc of a punch P for stamping the retaining ring for shaft of the first and the second embodiment have wider areas to contact material, and inner notch forming regions Aa, Ab, Ac and concave lobe forming regions Ba, Bb, Bc of the dye blade A and the lobe forming regions Pa, Pb, PC and the concave inner notch forming regions Qa, Qb, Qc of the punch P are smoothly continuous, the die blade A and the punch P are not difficult to get chipped, thus improving a service life and being able to provide for high-speed processing.

1. A retaining ring for shaft comprising four projections formed in an inner periphery of a C-shaped base material having an opening portion at one place of an outer periphery that expands toward an outer circumference, spaces between the adjacent projections serving as inner notches, and inner edges of the projections shaped like a convex circular arc circumscribed to an outer circumferential surface of a mounting region in a shaft.

2. A retaining ring for shaft comprising three projections formed in an inner periphery of a C-shaped base material having an opening at one place of outer periphery that expands toward an outer circumference, spaces between the adjacent projections serving as inner notches, and inner edges of the projections not only circumscribed to an outer circumferential surface of a mounting region in a shaft, but also shaped like a convex circular arc having a larger diameter than that of a circumferential surface of the mounting region in the shaft.

3. The retaining ring for shaft according to claim 1 wherein extended intersection points of lateral edges of both sides of the opening portion are set farther than a center of a tangent circle of the projections.

4. The retaining ring for shaft according to claim 1 wherein that not only the inner edges of the projections and lateral notches on both sides of the inner notches are made smoothly continuous, but also corners in a back side of the inner notches are made an R-shaped surface.

5. The retaining ring for shaft according to claim 1 wherein outer notches are provided in a region corresponding to a space between the adjacent inner notches in an outer periphery of the base material.

6. The retaining ring for shaft according to claim 1 wherein in that a concave portion is formed in an outer periphery of a region opposed to the opening portion in a base material.
